(19) United States
(12) Patent Application Publication
(10) Pub. No.: US 2026/0316826 A1
(43) Pub. Date: Oct. 15, 2026

(54) Method for Adjusting a Steering Feel in a Steering System

(71) Applicant: Robert Bosch GmbH, Stuttgart (DE)

(72) Inventors: Florian Rochel, Schorndorf (DE); Holger Schmitt, Ettlenschiess (DE)

(21) Appl. No.: 19/643,503

(22) Filed: Apr. 9, 2026

(30) Foreign Application Priority Data
Apr. 10, 2025 (DE) 10 2025 114 178.9

(51) Int. Cl. B62D 6/00

(52) U.S. Cl. CPC B62D 6/008

(57) ABSTRACT

In a method for adjusting a steering feel in a steering system, particularly during operation of the steering system in a vehicle, in which the steering system is configured as a steer-by-wire steering system having an operating unit with at least one steering handle as well as at least one feedback actuator coupled to the steering handle, a feedback torque is generated by controlling the feedback actuator to apply a steering resistance and/or a restoring torque to the steering handle. In at least one operating state in which a steering speed on the steering handle goes below a threshold, an additional torque is generated by controlling the feedback actuator to reduce and/or compensate for friction effects in the operating unit, in particular static friction effects.

This application claims priority under 35 U.S.C. § 119 to application no. DE 10 2025 114 178.9, filed on Apr. 10, 2025 in Germany, the disclosure of which is incorporated herein by reference in its entirety.

### BACKGROUND

The disclosure is based on a method for adjusting a steering feel in a steering system. The disclosure also relates to a computing unit for performing such a method and a vehicle comprising such a computing unit.

Vehicles with conventional steering systems are known from the prior art, in which a steering handle, for example in the form of a steering wheel, is mechanically connected to a wheel steering angle control element in the form of a steering gear via a steering column. In addition, vehicles comprising steer-by-wire steering systems are known which do not require a direct mechanical connection between a steering handle and the steered vehicle wheels and in which a steering specification is transmitted electrically. A typical steer-by-wire steering system usually comprises an operating unit with a steering handle and a feedback actuator for generating driver feedback, as well as a wheel steering angle control element that is mechanically separate from the operating unit for changing the wheel steering angle. The operating unit can either comprise a torsion rod torque sensor and be designed to be control-based or can operate without such a torsion rod torque sensor and act in a pre-control capacity, at least during an initial actuation.

In addition, a method for adjusting a steering feel in a steering system is known from DE 10 2017 222 952 A1, wherein the steering system is configured as a steer-by-wire steering system, and wherein a feedback torque is generated to apply a steering resistance and/or a restoring torque to the steering handle.

The task of this disclosure is, in particular, to provide a method for adjusting a steering feel with improved properties in terms of compensation for friction.

### SUMMARY

The disclosure relates to a method, in particular a computer-implemented method, for adjusting a steering feel in a steering system, particularly during operation of the steering system in a vehicle, wherein the steering system is configured as a steer-by-wire steering system and comprises an operating unit with at least one steering handle as well as at least one feedback actuator coupled to the steering handle, and wherein a feedback torque is generated by controlling the feedback actuator to apply a steering resistance and/or a restoring torque to the steering handle.

It is proposed that, in at least one operating state in which a steering speed on the steering handle goes below a threshold, an additional torque is generated by controlling the feedback actuator to reduce and/or compensate for static friction effects in the operating unit, in particular inherent adhesive friction effects. In the present case, a steering speed is thus particularly considered when generating the additional torque. For example, the threshold steering speed may be a maximum of ±10°/s, and preferably a maximum of ±5°/s. This design advantageously allows for friction compensation, in particular within the operating unit, and thus improves the steering feel. In particular, depending on the current driving situation, the stickiness effect can be reduced by reducing the friction effects in the operating unit, and the precision in the steering specification can be increased.

The vehicle is preferably configured as a motor vehicle and comprises the steering system configured as a steer-by-wire steering system, which includes the operating unit as well as at least one wheel steering angle adjuster, in particular mechanically decoupled from the operating unit, for changing a wheel steering angle of at least one vehicle wheel. The operating unit comprises the steering handle, which can in particular be manually operated by a driver, for applying a steering torque or hand torque, and the feedback actuator for driver feedback, preferably in the form of an electric motor, which actuator is connected to the steering handle and in particular can be controlled electrically. The feedback actuator is in particular mechanically coupled to the steering handle and is provided for generating a steering resistance and/or a restoring torque on the steering handle and thus generating a steering feel. In addition, the operating unit may comprise a coupling gearbox for linking the feedback actuator and/or at least one position sensor associated with the feedback actuator, preferably in the form of a rotor position sensor, for determining an operating position, preferably a rotor position, of the feedback actuator. Moreover, in the present case, the operating unit is preferably configured without a steering sensor, in particular a torsion rod-associated steering sensor, specifically a torsion rod torque sensor. In this case, the operating unit can operate in a pre-control capacity at least during initial actuation.

Furthermore, the vehicle comprises a computing unit, which is intended to perform the method for adjusting the steering feel. The term “computing unit” is mainly understood to mean an electrical and/or electronic unit having an information input, information processing, and an information output. Advantageously, the computing unit also has at least one processor, at least one operating memory, at least one input means and/or output means, at least one operating program, at least one control routine, at least one regulation routine, at least one calculation routine, at least one evaluation routine, at least one adaptation routine and/or at least one determination routine. In particular, the computing unit is at least provided, in at least one operating state in which a steering speed on the steering handle goes below a threshold, to generate an additional torque by controlling the feedback actuator, particularly in order to reduce and/or compensate for static friction effects in the operating unit. The computing unit can in particular comprise a compensation function. In addition, the computing unit is particularly provided to generate a feedback torque by controlling the feedback actuator in order to apply a steering resistance and/or a restoring torque to the steering handle. For this purpose, the computing unit can in particular comprise a steering feel function. Moreover, the computing unit is preferably provided to determine the steering speed at the steering handle and to compare it with the threshold. The steering speed can be determined, for example, based on a detection signal from the position sensor associated with the feedback actuator and optionally in connection with a gear ratio of the coupling gearbox. Preferably, the computing unit is further integrated into a control unit of the vehicle and/or a control unit of the steering system, in particular in the form of a steering control unit. The term “provided” is to be understood in particular as specifically programmed, designed and/or equipped. In particular, “provided for a specific function” is provided to be understood to mean that the object fulfills and/or performs this specific function in at least one in-use state and/or operating state.

It is further suggested that the additional torque acts towards a zero position and/or center position of the steering handle, which in particular can achieve a particularly effective friction compensation.

It is also advantageously proposed that the additional torque and/or a control variable correlated to the additional torque be increased and/or applied upon going below the threshold at a decreasing steering speed. For example, the additional torque and/or control variable may be increased and/or applied using a logarithmic function or a sigmoid function. However, preferably the additional torque and/or the control variable is increased and/or applied linearly, in particular by means of a ramp function. Above the threshold, the additional torque and/or the control variable is also preferably zero and/or set to zero. In particular, this can advantageously overcome static friction and achieve a gentle response of the operating unit.

Furthermore, it is proposed that a vehicle speed is considered in generating the additional torque. For example, the vehicle speed may be determined via an ESP system and/or a speed sensor or may be retrieved from a control unit of the vehicle. Preferably, at least a required amount of the additional torque, or more specifically, an additional torque required to reduce and/or compensate for the friction effects, is determined as a function of the vehicle speed. It is also particularly preferred in this context that the additional torque and/or a control variable correlated with the additional torque, in particular the previously mentioned control variable or a further control variable deviating from the previously mentioned control variable, is reduced and/or suppressed upon going below a further threshold for the vehicle speed with a decreasing vehicle speed. For example, the further threshold vehicle speed may be a maximum of 20 km/h, or a maximum of 15 km/h. In particular, the computing unit may be provided to determine the vehicle speed and compare it with the further threshold for the vehicle speed. For example, the additional torque and/or control variable may be reduced and/or suppressed using a logarithmic function or a sigmoid function. Advantageously, however, the additional torque and/or the control variable is reduced and/or suppressed linearly, in particular by means of a ramp function. At low vehicle speeds, for example during a parking or unparking maneuver, the additional torque is thus advantageously reduced or set to zero, because in this case, there is no self-aligning torque towards the zero position and/or the center position on the steering handle. This means that, particularly in driving situations and/or operating conditions in which the friction effects play a minor role, the generation of an additional torque can be omitted.

Furthermore, it is proposed that steering handle deflection is considered when generating the additional torque. The steering deflection of the steering handle can be determined, for example, based on a detection signal from the position sensor associated with the feedback actuator and optionally in connection with a gear ratio of the coupling gearbox. Particularly preferably, in this context it is also proposed that the additional torque and/or a control variable correlated with the additional torque, in particular the previously mentioned control variable or the previously mentioned further control variable or a further control variable deviating from the previously mentioned control variables, is reduced and/or suppressed upon going below a further threshold for deflection of the steering handle with decreasing deflection of the steering handle. For example, the further threshold for the deflection of the steering handle may be at most ±10° or at most ±5°. In particular, the computing unit may be provided to determine the deflection of the steering handle and to compare it with the further threshold for the deflection of the steering handle. For example, the additional torque and/or control variable may be reduced and/or suppressed using a logarithmic function or a sigmoid function. Advantageously, however, the additional torque and/or the control variable is reduced and/or suppressed linearly, in particular by means of a ramp function. With low deflections of the steering handle, in particular in the vicinity of the zero position and/or the center position, the additional torque is thus advantageously reduced or set to zero, because the additional torque in this range can lead to undesirable toggling back and forth between left and right operation. In particular, a deteriorated steering feel in the range of the zero position and/or the center position can be prevented as a result.

It is also preferably proposed that a steering feel function, in particular the previously mentioned steering feel function, is used to generate the feedback torque, and a compensation function, in particular the previously mentioned compensation function, acting and/or operating below the steering feel function, is used to generate the additional torque. The compensation function may be performed simultaneously with the steering feel function and/or in parallel with the steering feel function. In particular, the compensation function thus does not directly affect the steering feel function, but works below it, i.e., on a separate, additional functional level. This can in particular provide a particularly comfortable steering feel and a gently responsive operating unit.

The method for adjusting the steering feel and the vehicle are not intended to be limited to the application and embodiment described hereinabove. In particular, the method for adjusting the steering feel and the vehicle in order to achieve the functioning described herein may comprise a number of individual elements, components, and units that differ from the number specified herein.

### BRIEF DESCRIPTION OF THE DRAWINGS

Further advantages follow from the description of the drawings below. The drawings show an exemplary embodiment of the disclosure.

The drawings show:

FIGS. 1a-b a vehicle with a steering system designed as a steer-by-wire steering system in a simplified representation,

FIG. 2 a simplified block diagram of a compensation function for reducing and/or compensating for friction effects in an operating unit of the steering system,

FIGS. 3a-c exemplary characteristic curves of the compensation function, and

FIG. 4 an example of a flowchart comprising the main method steps of a method for adjusting a steering feel in the steering system.

### DESCRIPTION OF THE EXEMPLARY EMBODIMENT

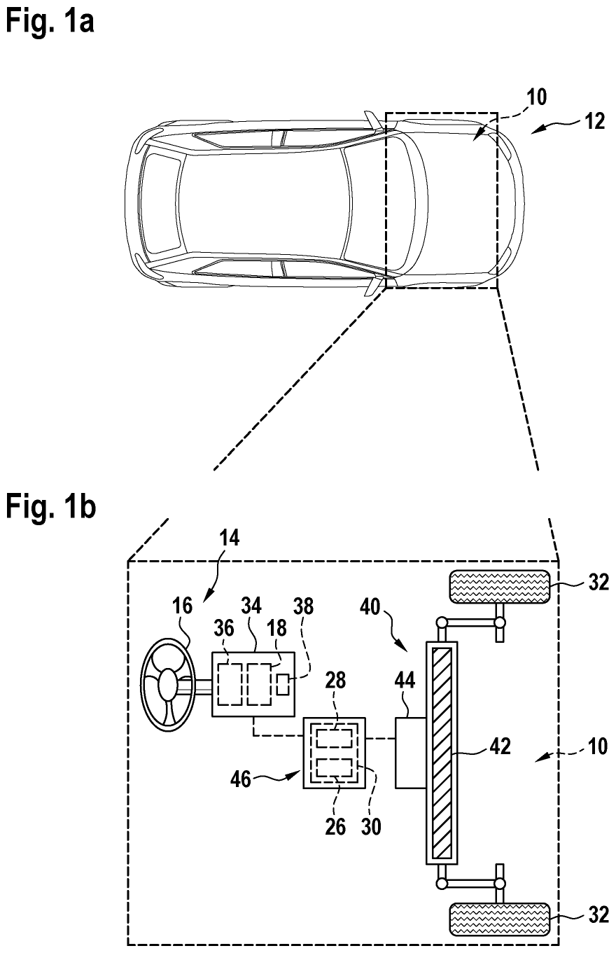

FIGS. 1a and 1b show a simplified illustration of a vehicle 12 which is, e.g., designed as a passenger vehicle comprising a plurality of vehicle wheels 32 and a steering system 10. The steering system 10 is operatively connected to the vehicle wheels 32 and is provided to influence a direction of travel of the vehicle 12. Furthermore, the steering system 10 is designed as a steer-by-wire steering system, in which a steering specification is transmitted electrically to the vehicle wheels 32 in at least one operating state.

The steering system 10 comprises an operating unit 14, in particular actuatable by a driver and/or an occupant. The operating unit 14 comprises a steering handle 16, for example, in the form of a steering wheel, and an actuator unit 34 which is connected to the steering handle 16. The actuator unit 34 is provided to sense signals, forces, and/or torques from the steering handle 16 and/or transmit them to the steering handle 16. To this end, the actuator unit 34 includes a feedback actuator 18 as well as a coupling gear box 36 for coupling the feedback actuator 18 to the steering handle 16. In principle, however, a coupling gear box could also be omitted, and a feedback actuator could be directly coupled to a steering handle. In the present case, the feedback actuator 18 is provided at least to generate a steering resistance and/or a restoring torque to the steering handle 16 and consequently to generate and/or adjust a steering feel. The feedback actuator 18 is configured, as an example, as an electric motor, in particular a rotation motor. The actuator unit 34 also comprises a position sensor 38 associated with the feedback actuator 18, which in the present case is configured as a rotor position sensor and is provided for determining a rotor position of the feedback actuator 18. In the present case, the operating unit 14 is in particular configured without a torsion rod torque sensor and operates in a pre-control capacity, at least during initial actuation.

In addition, the steering system 10 comprises a known wheel steering angle control element 40. The wheel steering angle control element 40 is mechanically separate from the operating unit 14. The wheel steering angle control element 40 is purely electrically connected to the operating unit 14. Furthermore, the wheel steering angle control element 40 is, e.g., designed as a central regulator. The wheel steering angle control element 40 is operatively connected to at least two of the vehicle wheels 32, in particular two front wheels, and is intended to convert a steering specification into a steering movement of the vehicle wheels 32. For this purpose, the wheel steering angle control element 40 comprises a steering regulator element 42 designed (by way of example) as a gear rack, and a steering actuator 44 that interacts with the steering regulator element 42. The steering actuator 44 is provided to provide a steering torque and thereby, in particular, to control and/or affect a steering behavior of the steering system 10 and/or the vehicle 12. A steering system could in principle naturally also comprise a plurality of wheel steering angle control elements, in particular configured as single-wheel control elements, or a combination of a wheel steering angle control element configured as a central controller and a wheel steering angle control element configured as a single-wheel control element.

The vehicle 12 further comprises a control unit 46. In the present case, the control device 46 is designed as a steering control unit and is therefore part of the steering system 10. The control unit 46 also comprises an electrical connection to the operating unit 14. The control unit 46 comprises an electrical connection to the wheel steering angle control element 40. The control unit 46 thus couples the operating unit 14 to the wheel steering angle control element 40. The control unit 46 is provided for controlling an operation of the steering system 10.

The control unit 46 comprises a computing unit 30 for this purpose. The computing unit 30 comprises at least one processor (not depicted), e.g., in the form of a microprocessor, and at least one operating memory (not depicted). In addition, the computing unit 30 comprises at least one operating program stored in the operating memory with at least one control routine, at least one calculation routine, at least one evaluation routine, at least one adaptation routine, and at least one determination routine. Moreover, in the present case, the computing unit 30 includes a steering feel function 26, as well as a compensation function 28 subordinate to the steering feel function 26. In the present case, the computing unit 30 in particular has an operative connection to the feedback actuator 18 and is provided for controlling the feedback actuator 18. By means of the steering feel function 26, a feedback torque can be generated, in a known manner, by the feedback actuator 18 in order to apply a steering resistance and/or a restoring torque to the steering handle 16.

A control unit could also be different from a steering control unit and configured, e.g., as a single, central vehicle control unit having a central computing unit. It is also conceivable to provide separate control units and/or computing units for one wheel steering angle control element as well as one operating unit and communicatively interconnect them.

Moreover, the vehicle 12 may include other non-illustrated components and/or assemblies, such as a per se, known ESP system and/or a per se, known navigation system. Preferably, in this case, the control unit 46 will have an electrical connection to the ESP system and/or the navigation system. In principle, however, it is also conceivable to omit an ESP system and/or a navigation system.

In a control-based steering system, i.e., with a torsion rod torque sensor, mechanical friction in the steering system or in a steering system operating unit may typically be detected and compensated using the torsion rod torque sensor data. In contrast, friction compensation in a steer-by-wire steering system having an operating unit without a torsion rod torque sensor is problematic. In such cases, compensation for friction is generally not possible as long as no movement is detected by a position sensor, an alternative angle sensor, or by an estimate. This means that static friction effects in the operating unit must normally be overcome before detection and compensation can occur. However, these static friction effects may affect the steering feel by leading to increased stiffness, also referred to as the “stickiness effect,” or reduced steering precision, which ultimately negatively impacts the driving experience. In particular, the aforementioned “stickiness effect” often occurs in situations where the driver wants to make small steering corrections, for example while driving on a curve. This may lead to a lack of precision in returning to the zero or center position.

To improve friction compensation, a method for adjusting a steering feel, particularly that is perceptible by a driver on the steering handle 16 and that is particularly generated by feedback actuator 18 during operation of the steering system 10 in the vehicle 12, is proposed. The method is used in particular to improve the driving feel depending on the driving situation. In the present case, the computing unit 30 is additionally provided to perform the method and particularly comprises a computer program with corresponding program code means for this purpose.

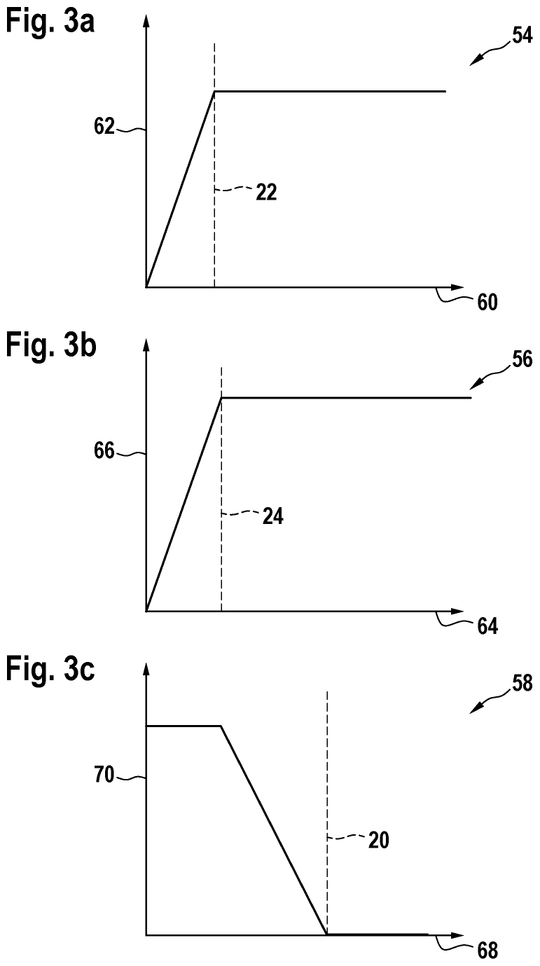

In the present case, particularly by means of the compensation function 28, in at least one operating state in which a steering speed ω_{LH} on the steering handle 16 goes below a threshold 20, an additional torque is generated towards a zero position and/or center position of the steering handle 16 by controlling the feedback actuator 18 to reduce and/or compensate for static friction effects in the operating unit 14, in particular adhesive friction effects. The additional torque is preferably flexibly adjustable to the maximum required amount so that the driver does not need to apply any additional steering torque to overcome the static friction effects when steering back. In the present case, the threshold 20 for the steering speed ω_{LH} can be, for example, ±5°/s, wherein the additional torque is increased and/or applied when the steering speed ω_{LH} goes below the threshold value 20 and is preferably set to zero above the threshold value 20 (cf. in particular also FIG. 3c). This configuration advantageously overcomes static friction effects in the operating unit 14. In addition, a gentle response can be achieved at least when steering back towards the steering wheel center.

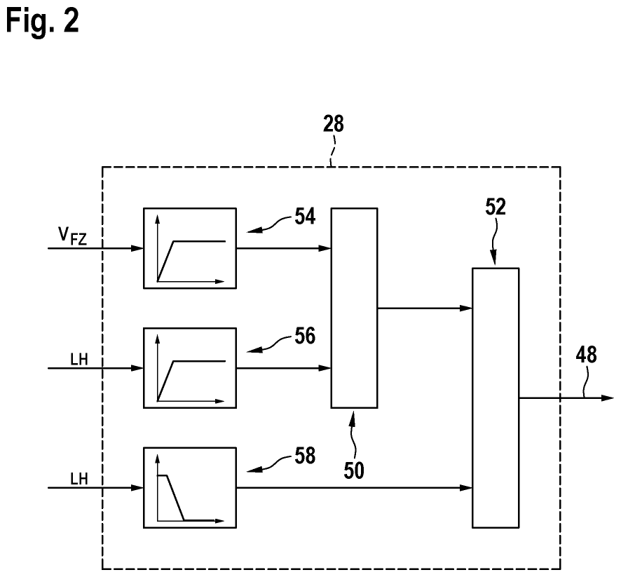

A detailed operation of the compensation function 28 will be described below with reference to FIGS. 2 and 3a to 3c. FIG. 2 shows a simplified block diagram of the compensation function 28 for reducing and/or compensating for friction effects in the operating unit 14, while exemplary characteristic curves of the compensation function 28 are shown in FIGS. 3a to 3c.

As input variables, a vehicle speed v_{FZ}, a deflection δ_{LH} of the steering handle 16, therefore a steering angle, as well as the steering speed ω_{LH}, are fed to compensation function 28. As an output variable, based on the input variables, the compensation function 28 provides a control signal 48 for the feedback actuator 18, which is used to generate the additional torque. To determine the output variable, the input variables or control variables determined from the input variables are processed with each other. In the present case, the vehicle speed v_{FZ} and the deflection δ_{LH} of the steering handle 16 or control variables correlated therewith are multiplied by each other in a first calculation block 50. The thus obtained calculation variable is then multiplied by the steering speed ω_{LH} or a control variable correlated therewith in a second calculation block 52 to determine the control signal 48.

Accordingly, in the present case, when generating the additional torque, the vehicle speed v_{FZ}, the deflection δ_{LH} of the steering handle 16, as well as the steering speed ω_{LH} are considered. For example, the vehicle speed v_{FZ} may be retrieved from the ESP system and/or the navigation system, while the deflection δ_{LH} of steering handle 16 and the steering speed ω_{LH} may be determined from a sensing signal of the position sensor 38 in association with a gear ratio of the coupling gear box 36.

A first setting block 54 in FIG. 2 further comprises a first characteristic curve for the vehicle speed v_{FZ} shown in FIG. 3a. In FIG. 3a, an abscissa axis 60 is configured as a variable axis and shows the vehicle speed v_{FZ} in [km/h]. An ordinate axis 62 is configured as a further variable axis and shows a corresponding control variable or, in the present case, a requested additional torque in [Nm].

In the present case, a required amount of the additional torque, or more specifically an additional torque required to reduce and/or compensate for the friction effects, is determined as a function of the vehicle speed v_{FZ}. For this purpose, the control variable or the requested additional torque is set to a maximum value above a further threshold 22 for the vehicle speed v_{FZ} and reduced and/or suppressed upon going below the further threshold 22 for the vehicle speed v_{FZ} with decreasing vehicle speed v_{FZ}. For example, the further threshold 22 for the vehicle speed v_{FZ} may be at most 20 km/h. Advantageously, the control variable or the requested additional torque is also reduced and/or suppressed linearly, in particular by means of a ramp function. At low vehicle speeds v_{FZ}, for example during a parking or unparking maneuver, the additional torque is thus advantageously reduced or set to zero, because in this case, there is no self-aligning torque towards the zero position and/or the center position on the steering handle 16.

A second setting block 56 in FIG. 2 comprises a second characteristic curve for the deflection δ_{LH} curve of the steering handle 16 shown in FIG. 3b. In FIG. 3b, an abscissa axis 64 is formed as a variable axis and shows the deflection δ_{LH} of the steering handle 16 in [°]. An ordinate axis 66 is configured as a further variable axis and shows a further control variable or, in the present case, an adjustment factor correlated with the additional torque.

In the present case, an adjustment factor for the aforementioned control variable or the requested additional torque is determined as a function of the deflection δ_{LH} of the steering handle 16. To this end, the further control variable or the adjustment factor is set to a maximum value above a further threshold 24 for the deflection δ_{LH} of the steering handle 16 and reduced and/or suppressed upon going below the further threshold 24 for the deflection δ_{LH} of the steering handle 16 with decreasing deflection δ_{LH} of the steering handle 16. For example, the further threshold 24 for the deflection δ_{LH} of the steering handle 16 may be at most ±5°. Advantageously, the further control variable or the adjustment factor is also reduced and/or suppressed linearly, in particular by means of a ramp function. With low deflections of the steering handle 16, in particular in the vicinity of the zero position and/or the center position, the additional torque is thus advantageously reduced or set to zero, because the additional torque in this range can lead to undesirable toggling back and forth between left and right operation.

A third setting block 58 in FIG. 2 comprises a third characteristic curve for the steering speed ω_{LH} shown in FIG. 3c. In FIG. 3c, an abscissa axis 68 is formed as the variable axis and shows the steering speed ω_{LH} in [°/s]. An ordinate axis 70 is configured as a further variable axis and shows a further control variable or, in the present case, a further adjustment factor correlated with the additional torque.

In the present case, a further adjustment factor for the aforementioned calculation variable is determined as a function of the steering speed ω_{LH}. For this purpose, the further control variable or the further adjustment factor is set to zero above the threshold 20 for the steering speed ω_{LH} and increased and/or applied to/at a maximum value upon going below the threshold 20 for the steering speed ω_{LH} with decreasing steering speed ω_{LH}. The threshold 20 for the steering speed ω_{LH} may be ±5°/s, as mentioned above. Advantageously, the further control variable or the further adjustment factor is also increased and/or applied linearly, in particular by means of a ramp function. This may advantageously overcome static friction in the operating unit 14 and achieve a gentle response of the operating unit 14.

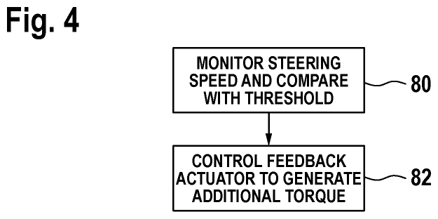

FIG. 4 finally shows an example of a flowchart comprising the main method steps of a method for adjusting the steering feel in the steering system 10.

In a method step 80, at least the steering speed ω_{LH} on the steering handle 16 is monitored and compared with the threshold 20.

A method step 82 corresponds to an operating state, in which the steering speed ω_{LH} goes below the threshold 20. As a result, the control signal 48 is determined for the feedback actuator 18 and, by controlling the feedback actuator 18 with the control signal 48, an additional torque is generated to reduce and/or compensate for friction effects in the operating unit 14, in particular static friction effects. The control signal 48 is determined at least as a function of the steering speed ω_{LH}. Also, advantageously, a vehicle speed v_{FZ} and/or a deflection δ_{LH} of the steering handle 16 may be considered.

The flowchart in FIG. 4 is merely intended to describe, by way of example, a method for adjusting the steering feel in the steering system 10. In particular, individual method steps may also vary, or additional method steps may be added. For example, consideration of a vehicle speed v_{FZ} and/or a deflection δ_{LH} of the steering handle 16 could also be omitted when determining the control signal 48.

1. A method for adjusting a steering feel in a steering system during operation of the steering system in a vehicle, said steering system being configured as a steer-by-wire steering system having an operating unit with at least one steering handle and at least one feedback actuator coupled to the steering handle, the method comprising:
controlling the feedback actuator to generate a feedback torque to apply a steering resistance and/or a restoring torque to the steering handle; and
in at least one operating state in which a steering speed on the steering handle falls below a threshold, controlling the feedback actuator to generate an additional torque to reduce and/or compensate for friction effects in the operating unit.

2. The method according to claim 1, wherein the additional torque acts towards a zero position and/or center position of the steering handle.

3. The method according to claim 1, wherein the controlling of the feedback actuator to generate the additional torque includes increasing the additional torque and/or applying a control variable correlated to the additional torque is in response to the steering speed falling below the threshold with decreasing steering speed.

4. The method according to claim 1, wherein the controlling of the feedback actuator to generate the additional torque includes considering a vehicle speed.

5. The method according to claim 4, wherein the controlling of the feedback actuator to generate the additional torque includes reducing and/or suppressing the additional torque and/or a control variable correlated to the additional torque in response to the vehicle speed falling below a further threshold with decreasing vehicle speed.

6. The method according to claim 1, wherein the controlling of the feedback actuator to generate the additional torque includes considering a deflection of the steering handle.

7. The method according to claim 6, wherein the controlling of the feedback actuator to generate the additional torque includes reducing and/or suppressing the additional torque and/or a control variable correlated to the additional torque in response to the deflection of the steering handle falling below a further threshold.

8. The method according to claim 1, wherein:
controlling the feedback actuator to generate the feedback torque includes generating the feedback torque using a steering feel function, and
controlling the feedback actuator to generate the additional torque includes using a compensation function acting and/or operating below the steering feel function.

9. A computing unit comprising:
a processor; and
non-transitory operating memory having program instructions that, when executed, cause the processor to perform the method according to claim 1.

10. A vehicle comprising:
a steering system, which is configured as a steer-by-wire steering system and comprises an operating unit with at least one steering handle and at least one feedback actuator coupled to the steering handle; and
the computing unit according to claim 9.

11. The method according to claim 1, wherein the controlling of the feedback actuator to generate the additional torque includes generating the additional torque to reduce and/or compensate for static friction effects in the operating unit.

12. The method according to claim 3, wherein the additional torque and/or the control variable correlated to the additional torque is increased and/or applied linearly upon the steering speed falling below the threshold with decreasing steering speed.

13. The method according to claim 5, wherein the controlling of the feedback actuator to generate the additional torque includes linearly reducing and/or suppressing the additional torque and/or the control variable in response to the vehicle speed falling below the further threshold with decreasing vehicle speed.

14. The method according to claim 7, wherein the controlling of the feedback actuator to generate the additional torque includes linearly reducing and/or suppressing the additional torque and/or the control variable correlated to the additional torque in response to the deflection of the steering handle falling below the further threshold.

15. The vehicle according to claim 10, wherein the vehicle is a motor vehicle.
